(19) United States
(12) Patent Application Publication
(10) Pub. No.: US 2026/0100066 A1
(43) Pub. Date: Apr. 9, 2026

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventor: Hironori AOKAGE, Nagoya-shi (JP)

(73) Assignee: TOYOTA JIDOSHA KABUSHIKI KAISHA, Toyota-shi (JP)

(21) Appl. No.: 19/213,122

(22) Filed: May 20, 2025

(30) Foreign Application Priority Data
Oct. 4, 2024 (JP) 2024-175278

(51) Int. Cl. G06V 30/196; G06V 20/56; G06V 20/62

(52) U.S. Cl. CPC G06V 30/1983; G06V 20/56; G06V 20/625

(57) ABSTRACT

An information processing device includes a communication unit and a controller. The communication unit is configured to receive a license plate list that is a list of character strings of license plates to be detected from a server. The controller is configured to recognize a character string of a license plate from a camera video captured by an in-vehicle camera, and when the recognized character string is included in the license plate list, transmit a video in which the camera video is obfuscated to the communication unit when an accuracy of the recognition is equal to or less than a high accuracy threshold, and transmit the recognized character string to the communication unit when the accuracy of the recognition exceeds the high accuracy threshold.

### CROSS-REFERENCE TO RELATED APPLICATION

This application claims priority to Japanese Patent Application No. 2024-175278 filed on Oct. 4, 2024. The disclosure of the above-identified application, including the specification, drawings, and claims, is incorporated by reference herein in its entirety.

### BACKGROUND

### 1. Technical Field

The present disclosure relates to an information processing device and an information processing method.

### 2. Description of Related Art

In the related art, there is known a technology in which a camera installed in a parking lot captures an image of a license plate of a vehicle present in the parking lot and manages the vehicle. For example, Japanese Unexamined Patent Application Publication No. 2009-238124 (JP 2009-238124 A) discloses an imaging device including an imaging unit configured to capture a video of a surface of a license plate of a vehicle present at a predetermined position in a parking lot, and a character data conversion unit configured to identify characters from the captured video of the surface of the license plate and convert the characters into character data. The imaging device further includes a character data collation unit configured to collate the converted character data with character data stored in advance, and a transmission unit configured to transmit collation result data indicating a collation result to an external device.

### SUMMARY

However, although the technology described in JP 2009-238124 A performs the collation of the license plate, all the collated information is transmitted to a server, so that privacy may not be taken into consideration.

The present disclosure is to quickly extract useful and highly relevant public information from image information of an in-vehicle camera and provide the information while taking privacy into consideration.

An information processing device according to an embodiment of the present disclosure includes a communication unit and a controller.

The communication unit is configured to receive, from a server, a license plate list that is a list of character strings of license plates to be detected.
The controller is configured to recognize a character string of a license plate from a camera video captured by an in-vehicle camera, transmit, via the communication unit, in a case where the recognized character string is included in the license plate list, and an accuracy of the recognition is equal to or less than a high accuracy threshold, a video in which the camera video is obfuscated, and transmit, via the communication unit, in a case where the accuracy exceeds the high accuracy threshold, the recognized character string.

An information processing method according to an embodiment of the present disclosure includes:
transmitting, by a server, a license plate list that is a list of character strings of license plates to be detected;
receiving the license plate list, recognizing a character string of a license plate from a camera video captured by an in-vehicle camera, transmitting, in a case where the recognized character string is included in the license plate list, and an accuracy of the recognition is equal to or less than a high accuracy threshold, an obfuscated video in which the camera video is obfuscated, to the server, and transmitting, in a case where the accuracy exceeds the high accuracy threshold, the recognized character string to the server, by an information processing device; and
storing the obfuscated video or the character string by the server.

According to the embodiments of the present disclosure, useful and highly relevant public information can be quickly extracted from image information of the in-vehicle camera, and information can be provided while taking privacy into consideration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of an information processing system according to an embodiment;

FIG. 2 is a diagram illustrating processing of a collation unit of an information processing device according to the embodiment; and

FIG. 3 is a flowchart showing a processing procedure example of the information processing method according to the embodiment.

### DETAILED DESCRIPTION OF EMBODIMENTS

### Configuration of Information Processing System

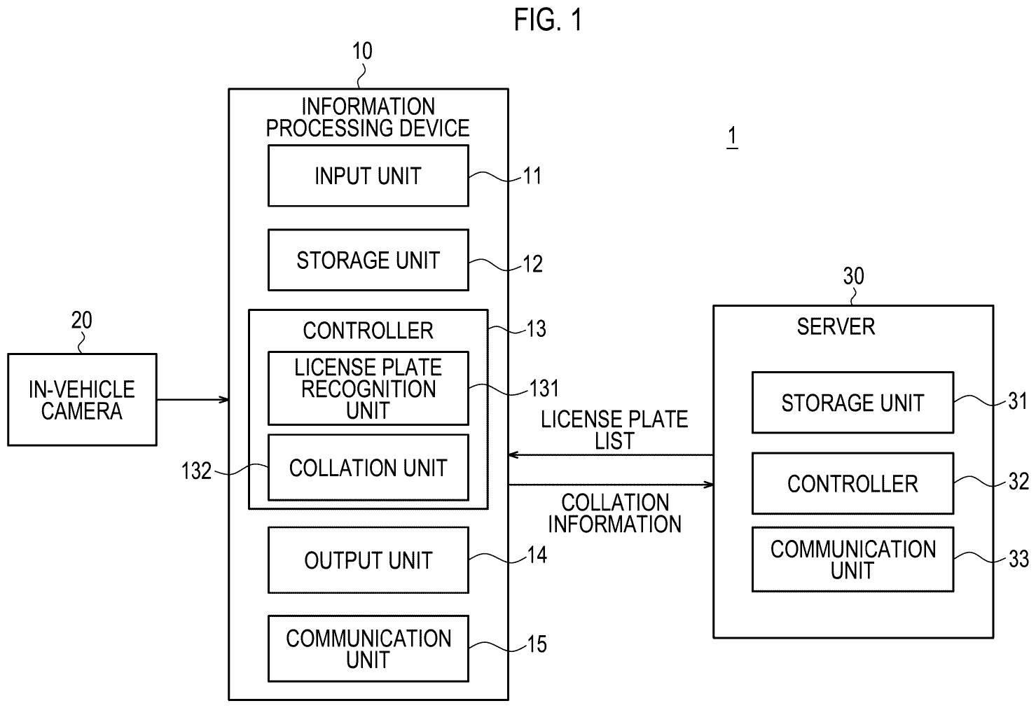

A configuration of an information processing system according to an embodiment will be described with reference to FIG. 1. The information processing system 1 shown in FIG. 1 includes an information processing device 10, an in-vehicle camera 20, and a server 30.

The in-vehicle camera 20 is connected to the information processing device 10. The in-vehicle camera 20 may be integrated with the information processing device 10. A plurality of the in-vehicle cameras 20 may be mounted on a vehicle. The in-vehicle camera 20 has an imaging device and captures a video of the periphery of the vehicle.

The server 30 acquires and stores a license plate list that is a list of character strings of license plates to be detected in advance from the police. The license plate to be detected is, for example, a license plate of a vehicle related to a crime, an incident, a traffic accident, or the like.

The information processing device 10 is a device mounted on a moving vehicle and performs wireless communication with the server 30. The information processing device 10 illustrated in FIG. 1 includes an input unit 11, a storage unit 12, a controller 13, an output unit 14, and a communication unit 15.

The input unit 11 includes at least one input interface. The input interface is, for example, a physical key, a capacitive key, a pointing device, a touch screen provided integrally with a display, or a microphone. The input unit 11 includes an interface with the in-vehicle camera 20. The input unit 11 inputs real-time video (hereinafter, referred to as “camera video”) captured by the in-vehicle camera 20.

The storage unit 12 includes at least one semiconductor memory, at least one magnetic memory, at least one optical memory, or any combination thereof. The semiconductor memory is, for example, a random-access memory (RAM), a read-only memory (ROM), or a flash memory. The flash memory is, for example, a solid-state drive (SSD). The magnetic memory is, for example, a hard disk drive (HDD). The storage unit 12 stores the camera video.

The output unit 14 includes at least one output interface. The output interface is, for example, a display that outputs information by video or a speaker that outputs information by sound. The display is, for example, a liquid crystal display (LCD) or an organic electroluminescent (EL) display.

The communication unit 15 includes at least one wireless communication interface for performing wireless communication with the server 30.

The controller 13 includes at least one processor, at least one programmable circuit, at least one dedicated circuit, or any combination thereof. The processor is a general-purpose processor, such as a central processing unit (CPU) or a graphics processing unit (GPU), or a dedicated processor specialized for specific processing. The programmable circuit is, for example, a field-programmable gate array (FPGA). The dedicated circuit is, for example, an application specific integrated circuit (ASIC). The controller 13 executes processing related to an operation of the information processing device 10 while controlling each of the units of the information processing device 10. The controller 13 includes a license plate recognition unit 131 and a collation unit 132.

The license plate recognition unit 131 acquires the camera video captured by the in-vehicle camera 20 and recognizes a character string (characters and numerals) of the license plate. Specifically, the license plate recognition unit 131 detects an image of the license plate from the camera video. The license plate recognition unit 131 may input the camera video to the machine learning model trained with the image of the license plate as a correct label, and detect the image of the license plate. The license plate recognition unit 131 recognizes a character string of the license plate from the image of the license plate by using existing recognition technology, such as optical character recognition/reader (OCR). The license plate recognition unit 131 obtains the recognition accuracy (reliability) each time recognition is performed, and outputs the recognized character string to the collation unit 132 together with the recognition accuracy.

The collation unit 132 acquires the license plate list from the server 30 via the communication unit 15, and collates the character string recognized by the license plate recognition unit 131 with the license plate list. The collation unit 132 transmits the collation information to the server 30 in a case where the recognized character string is determined to be included in the license plate list. The collation information is information including the time at which the collation unit 132 collates, the position information of the information processing device 10 (vehicle equipped with the information processing device 10) at the time, and the obfuscated camera video or the recognized character string.

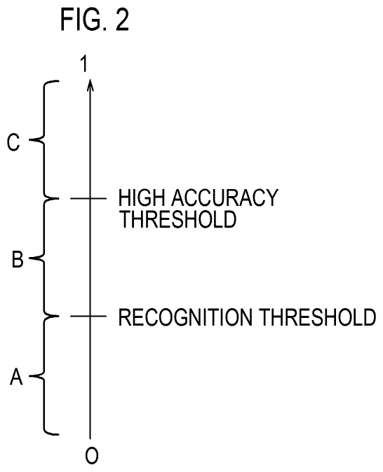

A process of the collation unit 132 will be described with reference to FIG. 2. In FIG. 2, the minimum value of the recognition accuracy is set to 0, and the maximum value is set to 1. The region A is a region in which the accuracy is equal to or less than the recognition threshold. When the accuracy corresponds to the region A, the collation unit 132 regards the recognition as a failure and does not collate the character string recognized by the license plate recognition unit 131 with the license plate list. In this way, the possibility of providing erroneous information due to erroneous recognition can be reduced.

The region B is a region in which the accuracy exceeds the recognition threshold and is equal to or less than the high accuracy threshold. When the accuracy corresponds to the region B, the recognition is successful, but the accuracy is not high, so that the camera video used for the recognition is obfuscated and then transmitted to the server 30. Specifically, the collation unit 132 detects an image related to privacy from the camera video used for recognition. The collation unit 132 may input the camera video to the machine learning model trained with the image related to privacy as a correct label and detect the image related to privacy. Then, the collation unit 132 performs a blurring process, a mosaic process, a filling process, or the like on the image related to the privacy by the existing image processing technology to obfuscate the image. The collation unit 132 causes the communication unit 15 to transmit the obfuscated camera video to the server 30. By obfuscating the camera video, it is possible to provide the information while considering the privacy. In addition, the police that acquire the information can analyze the video to specify the vehicle type or the like, so that the accuracy of the information can be improved.

The region C is a region in which the accuracy exceeds a high accuracy threshold. When the accuracy is in the region C, the accuracy of the recognition is high, and thus there is no need to transmit the video, and the character string of the recognized license plate is transmitted to the server 30 by the communication unit 15. In this case, since the video is not transmitted, there is no privacy problem, and the amount of information can be reduced.

The server 30 includes a storage unit 31, a controller 32, and a communication unit 33.

The storage unit 31 includes at least one semiconductor memory, at least one magnetic memory, at least one optical memory, or any combination thereof. The storage unit 31 stores a license plate list. The storage unit 31 stores collation information indicating the collation result.

The controller 32 includes at least one processor, at least one programmable circuit, at least one dedicated circuit, or any combination thereof. The controller 32 executes processing related to the operation of the server 30 while controlling each of the units of the server 30.

The communication unit 33 includes at least one wireless communication interface for performing wireless communication with the information processing device 10. The communication unit 33 transmits the license plate list to the information processing device 10. The communication unit 33 receives the collation information from the information processing device 10 and stores the collation information in the storage unit 31. Although one server 30 is used in the embodiment, a server that stores the license plate list and transmits the license plate list to the information processing device 10, and a server that receives the collation information from the information processing device 10 and stores the collation information may be different servers.

### Operation Example

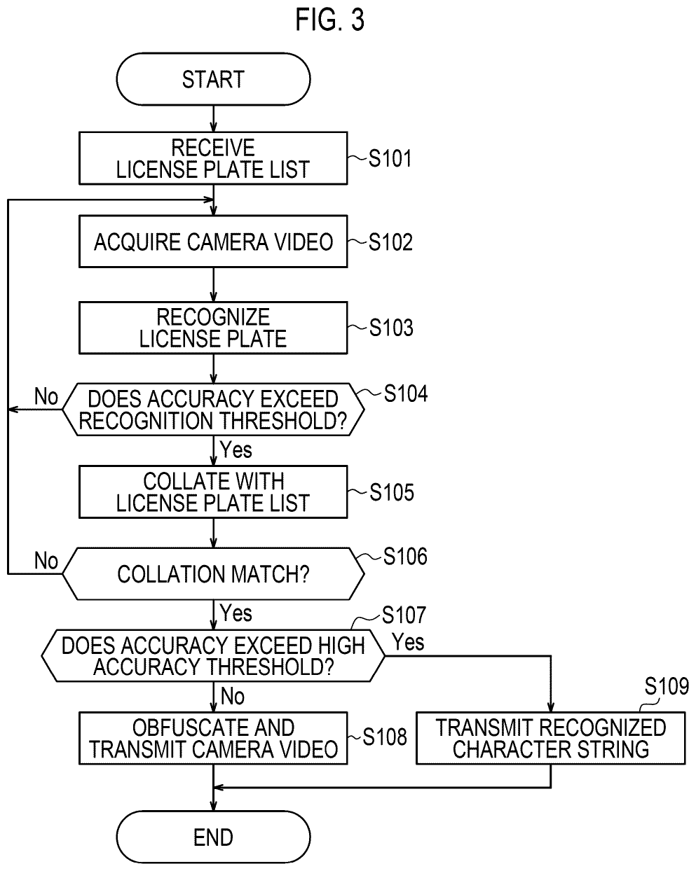

Next, a processing procedure example of the information processing method will be described with reference to FIG. 3.

The information processing device 10 receives the license plate list from the server 30 (S101).

The information processing device 10 acquires the camera video from the in-vehicle camera 20 (S102) and recognizes the character string of the license plate by the license plate recognition unit 131 (S103) while the vehicle on which the information processing device 10 is mounted travels.

When the accuracy of the recognition exceeds the recognition threshold (Yes in S104), the information processing device 10 collates the character string recognized by the license plate recognition unit 131 with the license plate list acquired from the server 30 (S105). When the recognition accuracy is equal to or less than the recognition threshold (No in S104), the collation is not performed, and the process returns to S102.

The information processing device 10 compares the accuracy with a high accuracy threshold when the collation unit 132 determines that the character string recognized by the license plate recognition unit 131 is included in the license plate list (in a case of collation matching) (Yes in S106). When the collation is not matched (No in S106), the process returns to S102.

When the accuracy of the recognition is equal to or less than the high accuracy threshold (No in S107), the information processing device 10 transmits the video in which the camera video is obfuscated to the server 30 together with the time when the collation is performed and the position information of the vehicle (S108). When the accuracy of the recognition exceeds the high accuracy threshold (Yes in S107), the information processing device 10 transmits the recognized character string to the server 30 together with the time when the collation is performed and the position information of the vehicle (S109).

As described above, the information processing device 10 receives the license plate list from the server 30, recognizes the character string of the license plate from the camera video captured by the in-vehicle camera 20, and the recognized character string may be included in the license plate list. In this case, the information processing device 10 compares the accuracy of the recognition with a high accuracy threshold, and transmits the video in which the camera video is obfuscated to the server 30 when the accuracy is equal to or less than the high accuracy threshold, and transmits the recognized character string to the server 30 when the accuracy exceeds the high accuracy threshold. Therefore, it is possible to quickly extract useful and highly relevant public information from the image information of the in-vehicle camera 20 and provide the information while considering privacy.

### Program

The function of the information processing device 10 may be realized by executing the program according to the present embodiment by the processor as the controller 13 (that is, by software). The program causes the computer to function as the information processing device 10 by causing the computer to execute the operation of the information processing device 10.

The program may be stored on a non-transitory computer-readable medium. The medium is a flash memory, a magnetic recording device, an optical disk, an optical magnetic recording medium, a ROM, or the like. The program is distributed by selling, transferring, or lending the portable medium. The portable medium is a secure digital (SD) card, a digital versatile disc (DVD), a compact disc read-only memory (CD-ROM), or the like, in which the program is stored. The program may be stored in the storage of the server and the program may be transferred from the server to another computer to distribute the program. The program may be provided as a program product.

For example, a computer temporarily stores the program recorded on the portable recording medium or the program transferred from the server in a main storage device. Then, the computer reads the program stored in the main storage device by means of a processor, and executes processing according to the read program by means of the processor. The computer may read the program directly from the portable recording medium and execute the processing according to the program. The computer may sequentially execute the processing according to the received program each time the program is transferred from the server to the computer. The processing may be executed by a so-called application service provider (ASP) type service that does not transfer the program from the server to the computer and realizes the function solely by the execution instruction and the result acquisition. The program includes information provided for processing by an electronic computer and information equivalent to the program. For example, data that is not a direct command with respect to a computer but has a property of defining processing of the computer corresponds to “information equivalent to the program”.

The above-described embodiments are representative examples, and various modifications or changes can be made without departing from the spirit of the present disclosure. For example, a plurality of configuration blocks or processing steps described in the embodiment can be combined into one or one can be divided into a plurality.

What is claimed is:

1. An information processing device comprising:
a communication unit configured to receive, from a server, a license plate list that is a list of character strings of license plates to be detected; and
a controller configured to recognize a character string of a license plate from a camera video captured by an in-vehicle camera, transmit, via the communication unit, in a case where the recognized character string is included in the license plate list, and an accuracy of the recognition is equal to or less than a high accuracy threshold, a video in which the camera video is obfuscated, and transmit, via the communication unit, in a case where the accuracy exceeds the high accuracy threshold, the recognized character string.

2. The information processing device according to claim 1, wherein the controller is configured to, in the case where the accuracy of the recognition is equal to or less than the high accuracy threshold, detect an image related to privacy from the camera video, and perform a blurring process, a mosaic process, or a filling process on the image to obfuscate the camera video.

3. The information processing device according to claim 1, wherein the controller is configured not to collate the recognized character string with the license plate list in a case where the accuracy of the recognition is equal to or less than a recognition threshold.

4. An information processing method comprising:
transmitting, by a server, a license plate list that is a list of character strings of license plates to be detected;
receiving the license plate list, recognizing a character string of a license plate from a camera video captured by an in-vehicle camera, transmitting, in a case where the recognized character string is included in the license plate list, and an accuracy of the recognition is equal to or less than a high accuracy threshold, an obfuscated video in which the camera video is obfuscated, to the server, and transmitting, in a case where the accuracy exceeds the high accuracy threshold, the recognized character string to the server, by an information processing device; and
storing the obfuscated video or the character string by the server.
